(19) United States
(12) Patent Application Publication
(10) Pub. No.: US 2009/0094287 A1
(43) Pub. Date: Apr. 9, 2009

(54) Computerized Game and Associated Physical Game Piece for Trading and Tracking via an Online Community

(76) Inventors: Robin M. JOHNSON, Davidson, NC (US); Emily L. JOHNSON, Davidson, NC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/245,468

(22) Filed: Oct. 3, 2008

Related U.S. Application Data
(60) Provisional application No. 60/977,094, filed on Oct. 3, 2007.

(51) Int. Cl. G06F 17/30; A63F 9/24; A63F 3/00

(52) U.S. Cl. 707/104.1; 463/42; 273/236; 707/E17.009

(57) ABSTRACT

A computerized game and physical game piece provide the basis for establishing communication among members of an online community. An individual purchases or trades for a game piece which has a serial number thereon. The game piece also has a design that is representative of a message that individuals desire to convey. The game pieces are carried in a holder that allows for convenient trading of game pieces in the real world. Upon receiving a game piece, the individual registers the game piece on a website and is given access to a game piece profile and member profiles on the systems. Communications between members of the online community are based upon common ownership of the game piece. The online community includes messaging among members and online discussions regarding the game pieces and the messages thereon. The website tracks the series of possessors of game pieces and their real world locations.

### CROSS-REFERENCE TO RELATED APPLICATIONS

This application claims the benefit of priority based on co-pending U.S. Provisional Patent Application Ser. No. 60/977,094 filed in the United States Patent and Trademark Office on Oct. 3, 2007, which is hereby incorporated by reference in its entirety.

### FIELD OF THE INVENTION

The invention relates to a computerized game that includes a physical game piece that (i) features customized or personalized art, symbols, or text messages, (ii) is worn, carried, or displayed to the general public, (iii) is traded in the real world and (iv) is tracked online via an electronic database as possession of the game piece changes among members of an ever-expanding online community.

### BACKGROUND OF THE INVENTION

With the rise in popularity and use of the Internet, social networking over the Internet has become a popular phenomenon. Popular social networking sites include myspace.com and facebook.com. These websites are designed for and primarily used by young adults, and there are serious privacy concerns for users of these websites. Thus, these social networking websites are inappropriate for children and older minors (e.g., early to mid-teens).

There are websites designed for young children with limited social networking components. For example, websites such as clubpenguin.com and webkinz.com allow limited safe chatting, have interactive games for members, and provide some basic customizable features. These websites, however, have very limited social networking capabilities and are designed for young children, e.g. children as young as six years old.

Another popular Internet phenomenon involves tracking physical items over the Internet as they travel around the world. Wheresgeorge.com is a popular website, allowing users to enter the serial number for dollar bills of various denominations. This enables users to track where a particular bill has been and where it later goes. The dollar bills do not communicate any particular message reflective of the individuals who exchange currency, and the defacing of legal currency is not allowed or encouraged.

U.S. Pat. No. 7,037,166 to Shrock et al. discloses an adventure figure system in which collectable figurines are traded by their owners, who can then track their location through the Internet. Each figurine has a unique identification number, which can be registered online. The owner can also create a personalized profile for the figurine. After a figurine has been traded, subsequent possessors can, among other things, view the figurine's profile, post pictures and stories about the figurine, and email the owner if the owner permits. Thus, owners and later possessors of the figurines can track the travels of the figurines around the world. The figurine trading system disclosed by Shrock has limited social networking capabilities because the customizable profiles are geared towards the figurines rather than their owners.

The trading of wearable pins and personalized accessories is also popular. Disney pin trading is a popular activity, where guests can trade collectable pins with other guests and with cast members. Disney pin trading involves no component over the Internet, thus there is no way to track the movement of pins or engage in online social networking.

Children often engage in making and wearing customizable jewelry and accessories. These accessories can be traded with others. Like Disney pin trading, the trading of these personalized accessories involves no Internet component.

Accordingly a need exists for a personalized accessory trading game suitable for children, older minors, and even adults in which (i) the game piece can communicate customized messages via art, symbols, pictures, or text; (ii) the trading of the game piece can be tracked over the Internet, and (iii) users can engage in safe, age appropriate social networking.

### BRIEF SUMMARY OF THE INVENTION

The invention is a computer implemented method of tracking possession of a physical game piece among members of an online community who trade game pieces in the real world. The computerized method implements a network in which a database of unique serial numbers correspond to respective physical game pieces. The method allows a user to store a game piece profile on the network for access by members of the online community and further allows users to store individual's, or member, profiles as well. The method links individuals who have possessed common game pieces by allowing communications between member profile pages and game piece pages.

In a different embodiment, the invention is a computerized game and physical game piece combination in which the computerized method described above is implemented as a game for members of the online community. In a preferred embodiment, the game piece is a two-sided item with a message or design on one side and a serial number on the other. The player receives the game piece as either a new game piece or as a traded game piece. The player then accesses an online community via a website home page and develops game piece profiles and member profiles for communication there between. The game pieces provide a linking interest among members of the online community.

To make the game pieces readily accessible for trading, the combination of a game piece and computerized game may also include a game piece holder. Individuals wear or carry the holder, which retains game pieces therein. The game piece holder may be a piece of jewellery or other accessory that makes the game more interesting.

Overall, the computerized method provides an avenue for individuals to place into circulation game pieces with individualized or personalized messages. Individuals with common interests will most likely encounter and possess the same traded game pieces. Upon registering the game piece and registering as a member on the website, the computerized method and associated game of this invention allows individuals to communicate online. Individuals with commonly own game piece histories become a sub-group of the online community with the potential for substantive communication.

### BRIEF DESCRIPTION OF THE DRAWINGS

FIG. 1 is a flowchart showing the logical steps of the game according to this invention.

FIG. 2 is a game piece holder in the form of a bracelet according to this invention.

FIG. 3A is the front side of a game piece according to this invention.

FIG. 3B is the back side of the game piece of FIG. 3A.

FIG. 4 is a screen shot of the home page of the computerized game according to this invention.

FIG. 5 is a screen shot of a coin profile page according to this invention.

FIG. 6 is a screen shot of a member profile page according to this invention.

FIG. 7 is a flow chart of the computerized method according to this invention.

### DETAILED DESCRIPTION

The invention is a computerized game that is based upon possession of a physical game piece (300). In a preferred embodiment, the game piece (300) is a unique, personalized “coin” that can be worn, displayed or simply carried in a holder (200). In portions of this detailed description referring to trading coins, it is to be understood that a coin can be any game piece that individuals carry or have available on their person (i.e., a coin and a game piece are generally synonymous). Without limiting the invention in any way, the holder (200) may function as a clip, a zipper pull, or a piece of jewelry such as a necklace or bracelet. The holder (200) and game piece (300) may be displayed on hats, backpacks, luggage, blue jeans, tennis shoes, name tags, dog collars, necklaces, bracelets, anklets, or any item functioning as a holder (200). In sum, the game piece (300) can be displayed on any piece of clothing, any fashion accessory (e.g., backpack, purse, etc.), any piece of jewellery, any thing with a zipper, or any object capable of retaining a holder (200) with a game piece (300) therein. In a preferred embodiment, the holders are interlocking so that multiple holders fit together. One example of interlocking holders is a set of several bracelets that fit together when the outer edges are adjacent.

The game piece (300) can be customized by the owner to feature individualized, one-of-a-kind artwork that communicates the creator's message via text, symbols, pictures, or art. These individualized game pieces (300) can be registered to the owner online on an overall website (400). The website (400) will serve as the central registrar for the registering and tracking of any and all game pieces (300). It will also serve as the central registrar of any and all coins, pins, tokens, medallions, trinkets, or memorabilia serving as a unique game piece (300) with an authorized UPC-type code.

On the website (400), the creator or owner of a game piece (300) can also describe the significance and meaning of the artwork featured on his personalized game piece (300). Since each game piece will contain or display a unique, proprietary registration number, or serial number, and an individualized code, such as a UPC code, subsequent possessors can easily lookup the game piece (201) on the website (400) and review its travels, meanings, significance and even contribute to its evolving history.

The game pieces (300) and associated holders (200) are configured to make exchanging the game pieces (300) fun and easy. The game piece (300) is a standardized size and shape, so exchanged game pieces (300) will fit each persons' respective holders (200).

One goal of the invention is to create a global, never-ending chain of custody for each game piece (300) with corresponding entries on a social networking system. The original owner of the game piece (300) never knows where his game piece (300) may wind up, since it will be traded out by subsequent possessors. The game pieces are similar to “messages in a bottle” tossed into the global online community and floating from hand-to-hand, owner to owner. Each subsequent possessor can go online to the central registry home page (400) and look up the game piece (300) by the unique number on the game piece (302). Other options available in the online community are described in more detail below.

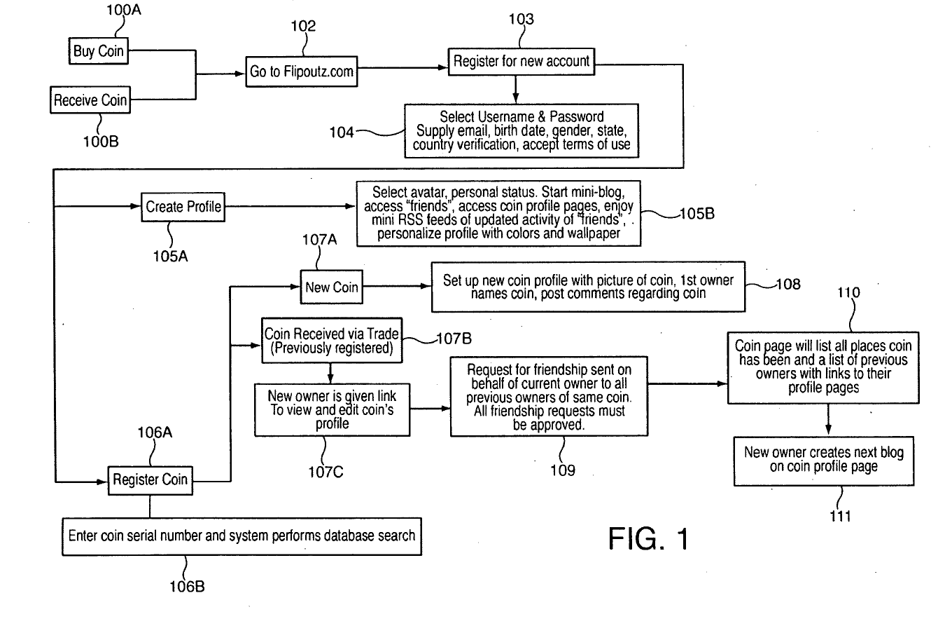

To fully explain the computerized game and physical game piece trading system, FIG. 1 (Blocks 100-111) sets forth a flow chart of a preferred embodiment of the invention. Without limiting the invention in any way, an individual who will ultimately become a member of the online community either buys a game piece (300) or receives the game piece in a trade (100A, 100B). Upon receiving the game piece, the individual goes to the home page (400) of the computerized game and social networking site (102). From that home page, the possessor of the game piece registers for a new account (103) on the website. To register for a new account, the possessor of the game piece selects a user name and password, gives an email address, and enters certain generic biographical information (birth date, gender, state, country), and then accepts the terms of use. See Block 104.

The home page (400) of this system includes features commonly used in the art of web based communications, such as animation and links to other parts of the website (e.g., information about the network, rules for the game, where to buy game pieces, frequently asked questions, and security/privacy issues). Without limiting the invention, the website (400) further includes options for regular users, logged-in users, and administrative users. Regular users include any person that visits the Website and has access to certain pages. A regular user does not have the secured access allowing interaction with other members of the online community. A logged in user is one who has registered an account and has passed the security screens to interact with other members on the site. A logged in user has access to all public features available in the online community. An administrative user is typically an owner, manager, or professional administrator of the site with management credentials to run the overall community via the home page (400). An administrative user has credentials that allow deleting messages that are inappropriate, activating and deactivating registered users, and reviewing all messages online for appropriate content.

In one embodiment, the content of the site may be scanned by software to ensure removal of messages or content that is not within the bounds desired by the online community (e.g., profanity, adult content). All user-related information is saved in a database and sensitive information such as passwords will be encrypted

The website will be run in standard operating environments that support web-based applications, particularly those that work on scalable servers as that term is used in the art of computers and electronics. The website is accessible by numerous web browsers. Data repositories, such as the database of serial numbers may be written in SQL or other database formats that are useful for this purpose.

The website used in the game and associated method include security features that protect individuals from unwanted or unauthorized communications. A simple “captcha” (Completely Automated Public Turing test to tell Computers and Humans Apart) may be required in certain embodiments to register a user.

Once the individual has created an account on the website, the individual is allowed to create a member profile within the online community (105A). In a preferred embodiment, the member profile (600) is appropriate for a wide range of age groups. In a particularly preferred embodiment, the website, the computerized game, the online community, the game pieces, and the overall social network are appropriate for children and families. To this end, the member profiles (600) refrain from using actual photographs of children or providing any identifiable information about the members of the online community.

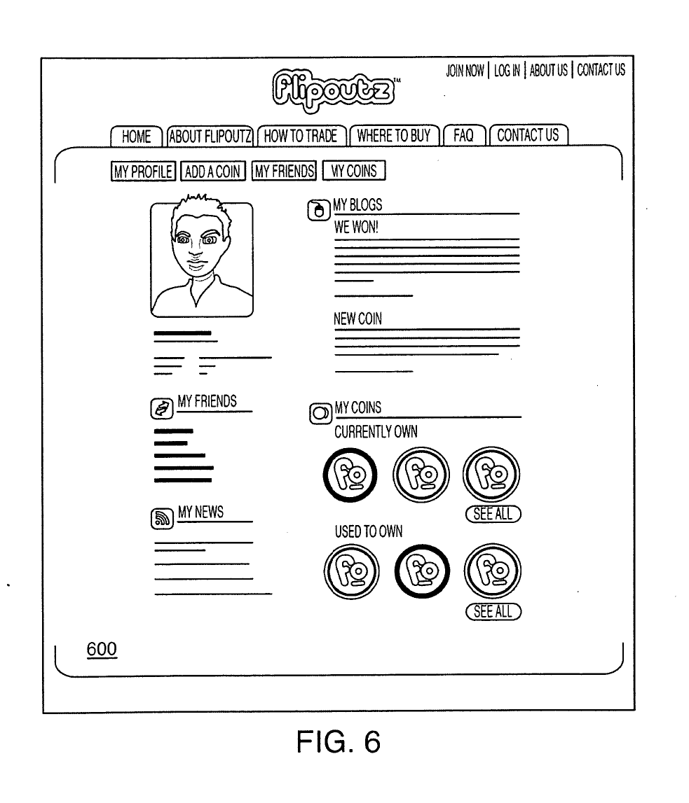

In one embodiment of this invention, the individual seeking to join the online community and play the computerized game would select an avatar (FIG. 6), or graphic image or icon, that represents the individual. This avatar may be selected from standard images, or in other embodiments, the avatar may be customizable in terms of facial features, eye color, hair color, and the like.

The member profile (600) incorporated into a computerized network is a gateway to communication. The individual creates the member profile on the network as a means of self expression. The avatar represents the individual, and the member profile allows that individual to add information about their life, their tastes, and interesting information that other members of the online community would find interesting.

Significantly, the member profile (600) allows an individual to post the game pieces (300) that they have possessed. In this way, the member profile (600) links the physical game piece, traded in real world interactions and transactions, to the virtual community.

This link between the physical, or real world, and the virtual community is important. Without limiting the invention, one of the goals of the computerized game, the physical game piece, and the linking online community is to allow individuals to express themselves. The way that the game pieces (300) are traded in the physical world allows people who encounter each other's messages to connect online if the messages are commonly appealing. The online meetings are safe for families and children because the website (400) is set up with security mechanisms and safeguards in place to prevent undesirable or unauthorized communications.

In achieving the goal of linking the game piece (300), the online community, the computerized game, and the individuals involved therein, the system allows for the creation of a profile for each of the game pieces (300). As shown in FIG. 1, the possessor of a game piece may be either the first person to register that game piece (e.g., a new game piece (107A)) or may be a subsequent possessor who received the game piece in a trade (107B). In the case of a subsequent possessor of the game piece, the game piece will be previously registered and already set up with a game piece profile.

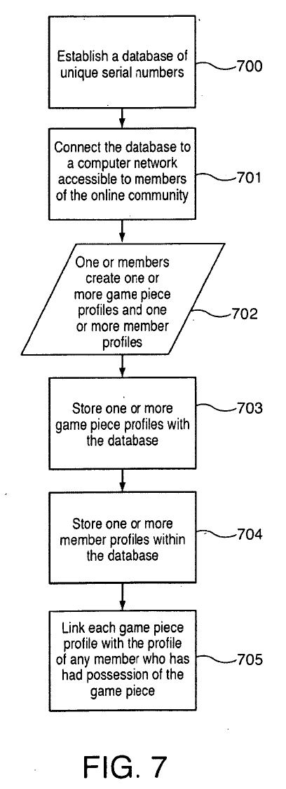

If the game piece is a new game piece, then the person registering it will type in the serial number (302) upon entering the home page (400) of the social networking website. The system then performs a database search (see FIG. 7) to determine whether the game piece has been registered previously. If the game piece is a new game piece, the system allows the user to set up a new game piece profile (500) with a picture of the game piece. It is significant that the picture of the game piece is pre-populated into the database with the serial number for every game piece in the system. For purposes herein, a picture may be a photograph, graphical image, or similar representation of the game piece.

When a user enters a serial number (302), the database responds with prompts directing the user to set up a new profile page for the new game piece (108) or link to a previously registered game piece's profile. Upon entering the game piece profile, the individual in possession of the game piece can view the previous owners of the game piece and all their geographical locations in the real world. Similarly, the individual has the option to request friendship and communicate with those prior owners. The prior owners must approve the friendship requests (109). The game piece profile page further includes opportunities to incorporate weblogs (“blogs”) into the game piece profile page. A weblog is an online post having continually updated commentaries on a web page.

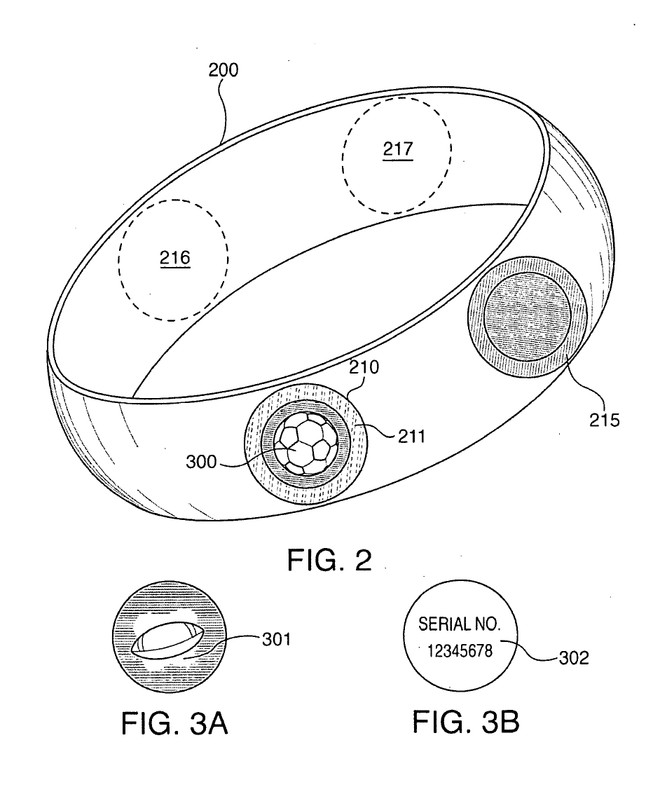

FIG. 2 shows one type of game piece holder (200) that can be used by individuals for real world game piece trades. The holder of FIG. 2 is in the form of a bracelet, but the bracelet could be replaced with any item that is convenient for individuals to carry with them, wear, or otherwise retrieve. The holder (200) defines pockets or recesses (210) therein for holding the game pieces in an attractive piece of jewellery or other accessory. The holder (200) may incorporate any structural feature that allows convenient retention of the game pieces and is not limited to the pockets of FIG. 2. In other words, the holder (200) may incorporate attachment mechanisms for the game pieces, including but not limited to clips, snaps, buttons, Velcro, or other means. The pocket (210) of FIG. 2, however, has a lip or overlapping edge (211) that holds the game piece in place. In the bracelet configuration, the lip or edge (211) engages the game piece and holds it in place, but allows retrieval and removal for impromptu trading. The pocket (215) on the right side of FIG. 2 is empty but available for inserting a game piece upon receipt. Pockets (216, 217) encircle the holder (200) on the opposite side.

The game pieces may take any form that is appealing to individuals for trading. FIGS. 3A and 3B show opposite sides (301, 302) of a game piece (300) in the form of a coin. The game piece (300) has a message, graphic, symbol, original art work, or any image on a first side that sends out the expression that an individual chooses to convey. The game pieces may be distributed with previously prepared images, or the system of this invention may incorporate methods of uploading original artwork and other text or designs for publication on an individual's personally distributed game piece. The flip side (302) of the game piece (300) includes a unique serial number for that single game piece.

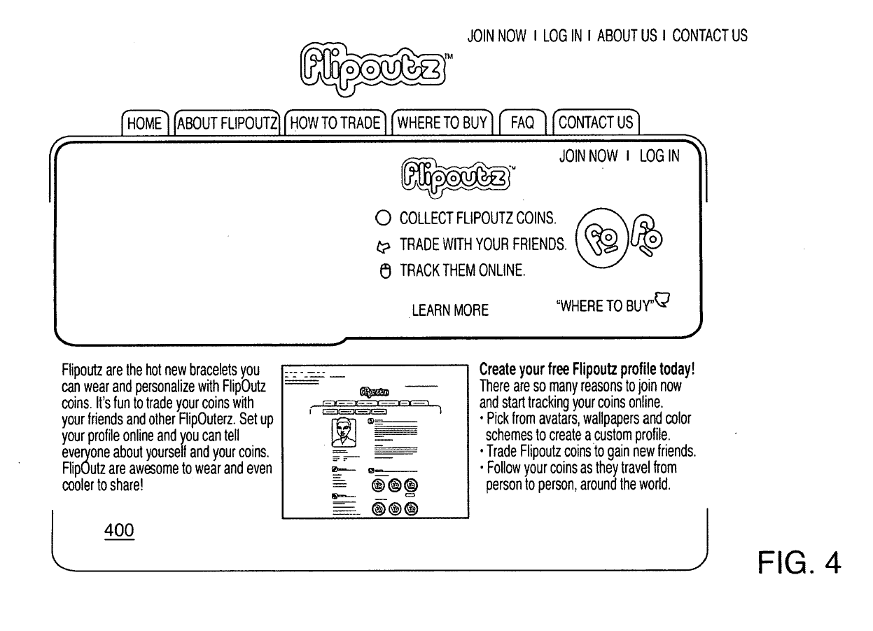

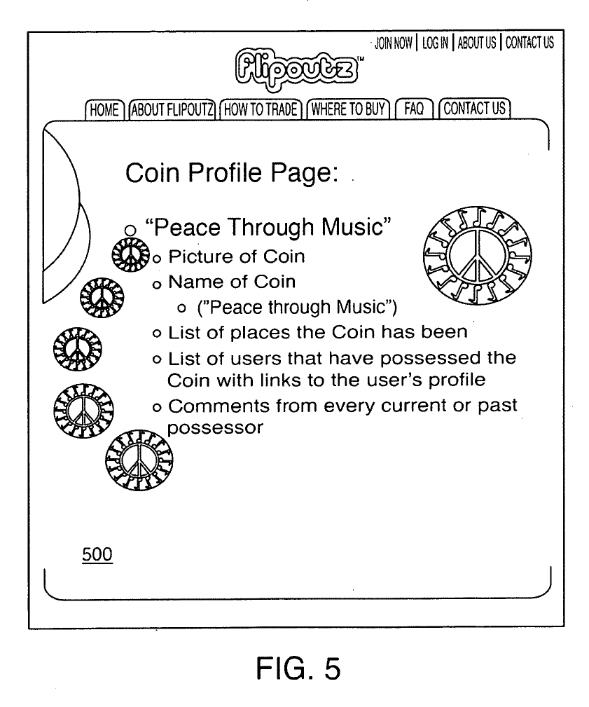

FIG. 4 shows a home page (400) for accessing the computerized game and online community of this invention. The home page (400) is a web page as known in the art of electronic communications today. The home page (400) includes links to other parts of the game and the online community, or social network, associated with players and individuals who possess the game pieces (300). As noted above, the website provides links to coin profile pages (FIG. 5) and member profile pages (FIG. 6).

In a preferred embodiment, a computer implemented method tracks possession of a physical game piece (300) among members of an online community who trade the game piece. The method includes the steps shown graphically in FIG. 7 of establishing a database (700) of unique serial numbers (302) corresponding to respective physical game pieces (300); connecting the database to a computer network for access by the members of the online community (701), wherein the computer network retrieves information from computer readable storage media at multiple locations; creating one or more game piece profiles and one or more member profiles (702); storing at least one game piece profile (500) on the computer network (703); storing at least one member profile (600) on the computer network (704); and linking the game piece profile (500) to any member profile (600) corresponding to a member of the online community who has had possession of the game piece (705).

The database used in the computer implemented method is part of a larger administration module within the system that is programmed in standard computer languages. The administration module includes, but is not limited to, software that manages the overall website, including the databases that contain member and game piece information. The administration module also provides data management for the profile generators discussed below and coordinates communications between member profiles and game piece profiles. To facilitate communications between member and game piece profiles, the administration module communicates with a linking module for directing electronic communications within the system. The linking module informs a sub-group of the social network that the sub-group has had possession of the same game piece. In addition, the linking module provides each member of the sub-group with the option of initiating communication with other members of the sub-group. The members of each sub-group have the option of declining any unwanted communications.

The database ultimately includes a unique serial number for each game piece (300) and a pre-loaded picture of the game piece for use on game piece profile pages. A user accesses the database by logging in to a home page (400) run as part of the administration module on a server or other controlling computer.

As noted in regard to the flowchart of FIG. 1, a user who purchases or receives a game piece enters the serial number (302) in the appropriate communications module that is part of the home page (400). By logging in and registering as an authorized user of the system, the individual is allowed to check to see if the serial number on the game piece is in the database already. The computerized method then allows for the game piece profile (500) to be established as set forth above and shown in FIG. 1. Similarly, a registered user is allowed to set up a member profile (600) using the website (400) as a starting point.

One of the interesting features of the computerized method is its ability to coordinate communication between members of an online community, or social network, by linking individuals who have possessed a common game piece (300). With numerous game piece profiles (500) and numerous member profiles (600) on the system, as multiple game pieces are traded in the real world, communications within the online community increase. In this sense, the traded game pieces provide the linking impetus for communication. The game pieces, of course, have images, designs, and messages that appeal to groups of individuals. For purposes herein, the term “design” is intended to encompass, but is not limited to, any aesthetic, ornamental, or information material on the game piece. Text, graphics, messages, and the like are all within the scope of a “design. In one sense, the game pieces allow individuals to “set their message free” in the real world and connect with others who are attracted to that message by providing communication opportunities in a family friendly online environment.

The linking of game piece profiles and member profiles is one aspect of the method that allows communications within the social network described herein. The game piece profile (500) includes features for members to learn more about the game piece (300), which is particularly important for customized game pieces with individualized messages and artwork. The game piece profile (500) includes a list of members of the online community who have possessed that game piece in the past, their locations, and possibly a graphical map showing the game piece's track all over the world. Members who access the game piece profile are given the option of posting a comment on the game piece profile page as well as requesting communication, or “friendship,” with one of the individuals who owned the game piece previously.

Once individuals have possessed the same game piece and found each other online by reviewing a game piece profile (500), the computer implemented method allows for authorized individuals to review one another's member profiles (600). As noted above, a member profile is typically a family-friendly and child-friendly web page with graphics, text, and images that are commonly used in the web-based arts today. In a preferred embodiment, an avatar represents the individual so that actual photographs of members are not necessary. The avatar feature is particularly advantageous for protecting children who participate on the website from unauthorized contact. The member profile is updatable in real time with blog communications, RSS feeds, and continuously updated lists of other online members in electronic communication with that individual.

In a different embodiment, a computerized game and physical game piece combination includes a physical game piece (300) traded among players; a computer network for tracking possession of the game piece (300) and providing information about individuals who have possessed the game piece (300). The computer network includes a database of unique serial numbers for each respective game piece and a computer readable storage medium with computer controlling commands stored thereon. The computer controlling commands provide the computer network with (i) a website home page for accessing the computerized game; (ii) a game piece profile generator; and (iii) a player profile generator. The term “generator” encompasses any computer programming that enables a user to create text and graphics associated with a profile used on the system. The players have access to both a game piece profile and a player profile published on the computer network.

The game pieces (300) can be any items that are tradable among individuals in the real world and configured for decoration with messages, artwork, designs, and other graphics. In a preferred embodiment, the game piece (300) is a coin (301, 302) with a message or design on one side (301) and a serial number (302) on the other. In a particularly preferred embodiment, the overall game includes a method of allowing an individual to “set their message free” in the real world and connect online with others who encounter that message. In this sense, the game piece may include artwork or text that an individual authors and customizes for publishing on a game piece (300). Without limiting the invention in any way, one game piece (300) is a metal or plastic coin with graphics thereon and coated with a clear polymer, such as a silicone based coating. The game pieces, then, become attractive trinkets or pieces of art that are desirable to more than one person for displaying and trading.

Individuals who encounter the message on a game piece (300) in the real world may trade game pieces among others who have purchased or otherwise received the game pieces. Upon receiving a game piece through purchase or trade, that individual has an opportunity to register a new account, including online contact information (e.g., email address), for sharing messages with others who have previously owned the same game piece, including the original creator or registrant. The online component allows for authorized users to access game piece profiles and member profiles within a social network.

The game piece profiles (500) and member profiles (600) within the network are customizable for more in-depth messaging opportunities within the online communities. Upon registering a new account for an individual member profile or a new game piece profile, the computerized system initiates computer commands, programmed in standard web based language, for enabling a member profile generator and/or a game piece profile generator. The user (a player or individual member of the online community) is allowed access to these generators for convenient customization of the profile pages.

In one preferred embodiment, the computerized game and method include computer controlling commands that initiate web page editing features programmed in accordance with web based applications known in the art today. The editing features related to a game piece profile are selected from the group consisting of adding a picture of a game piece, naming a game piece, listing physical locations of the game piece, listing prior owners of the game piece, and changing the background of the game piece profile. The editing features related to a player profile are selected from the group consisting of entering objective information about the player, selecting a computer graphic (e.g., an avatar) that represents the image of the player, changing the background of the player profile, and listing other players in electronic communication with the player.

Overall, the computerized game, game piece, and online community provide a way for individuals to create a message and send it out to others in the real world. The game piece (300) carries the message in the form of a design, graphic, artwork, or text and is easily traded as individuals see each other's messages. The game piece provides a link to the online community because the possessor of the game piece can use the game piece for access to certain portions of a web based online community, or social network. For purposes herein, individuals who have ever owned the same game piece become one sub-group of the online community. This sub-group has a common interest in the coin that each has possessed at some point and that common interest leads to substantive communications within the online community.

As noted above, the online community centers around, but is not limited to, member profile web pages and game piece profile web pages. The system has communication capabilities between the two. The profiles are managed, edited, coordinated, and otherwise updated by respective game piece and member profile modules that have been programmed into the system.

The social network includes numerous sub-groups of individuals who have seen the same message on a game piece in the real world, have been attracted to or intrigued by that game piece, and ultimately possessed that game piece and its associated message. In this sense, the sub-group is its own mini-community within the social network. The computerized system, game, and online community provide a way for members of these sub-groups to communicate with one another. Of course, for security reasons, the system is programmed to allow any member of the online community to initiate outgoing online communications and to decline incoming communications from any other member.

The computerized method, game, and social network of this invention is adaptable for diverse messaging opportunities and multiple types of entertainment. For example, the messages on the game piece may include commercial advertising, charitable advertising, or messages directed to particular groups.

In regard to the entertainment aspects of the system, the computerized game may include features such as a treasure hunt. The treasure hunt may be promoted online by listing serial numbers that entitle a participant to particular prizes. Upon registering one of the game pieces with a noted serial number, the individual would be notified that the game piece is a winner.

In a different embodiment, the administrator of the website may institute a contest by which individuals submit a design, and the winning design is chosen for manufacture and distribution on a game piece. The winner may be chosen by online voting. In yet another embodiment, the game piece may be issued in only limited quantities, making the game piece a collectible item. The website would publish information about the limited edition game pieces to inform participants of their special nature.

The above written description is not limiting of the invention but is particularly useful to explain the claims set forth below. Other embodiments of the invention may fall within the scope of the following claims.

1. A computer implemented method of tracking possession of a physical game piece among members of an online community who trade the game piece, the method comprising:
establishing a database of unique serial numbers corresponding to respective physical game pieces;
connecting the database to a computer network for access by the members of the online community, wherein the computer network retrieves information from computer readable storage media at multiple locations;
storing at least one game piece profile on the computer network;
storing at least one member profile on the computer network;
linking the game piece profile to any member profile corresponding to a member of the online community who has had possession of the game piece.

2. A computer implemented method according to claim 1, wherein the database includes a picture of the coin.

3. A computer implemented method according to claim 1, further comprising the step of logging in to a home page stored on the computer network.

4. A computer implemented method according to claim 1, wherein the step of logging in to the home page comprises communicating with an administration module on the network.

5. A computer implemented method according to claim 1, further comprising the step of registering a game piece by entering a serial number into the database.

6. A computer implemented method according to claim 1, further comprising the step of communicating data between at least two members of the group consisting of a plurality of game piece profiles and a plurality of member profiles.

7. A computer implemented method according to claim 1, further comprising the step of adding a picture of the game piece to the game piece profile.

8. A computer implemented method according to claim 1, further comprising the step of adding the name of the game piece to the game piece profile.

9. A computer implemented method according to claim 1, further comprising the step of updating the game piece profile by listing the locations in which a member of the online community has possessed the game piece.

10. A computer implemented method according to claim 1, further comprising the step of updating the game piece profile by listing the members of the online community who have possessed the game piece.

11. A computer implemented method according to claim 1, further comprising the step of posting a comment on the game piece profile page.

12. A computer implemented method according to claim 1, wherein the step of storing the member profile comprises selecting an avatar that graphically represents the member.

13. A computer implemented method according to claim 1, wherein the step of storing the member profile comprises entering a blog communication.

14. A computer implemented method according to claim 1, wherein the step of storing the member profile further comprises the step of listing friends in electronic communication with the member profile.

15. A computer implemented method according to claim 1, wherein the step of storing the member profile further comprises the step of receiving an update about other members of the online community on the member profile page.

16. A computerized game and physical game piece combination comprising:
a physical game piece traded among players;
a computer network for tracking possession of said game piece and providing information about individuals who have possessed the game piece, the computer network comprising:
a database of unique serial numbers for each respective game piece;
a computer readable storage medium with computer controlling commands stored thereon, the computer controlling commands providing on the computer network (i) a website home page for accessing the computerized game; (ii) a game piece profile generator; and (iii) a player profile generator,
wherein the players have access to both a game piece profile and a player profile published on the computer network.

17. A computerized game and physical game piece combination according to claim 16, wherein said game piece comprises a coin.

18. A computerized game and physical game piece combination according to claim 16, wherein said game piece is a collectible item.

19. A computerized game and physical game piece combination according to claim 16, wherein said game piece comprises a design selected from the group consisting of text, graphics, symbols, pictures, art, commercial advertising, and charitable advertising.

20. A computerized game and physical game piece combination according to claim 16, wherein said game piece comprises a message.

21. A computerized game and physical game piece combination according to claim 20, wherein said game piece conveys a message that is self-expressive of a member.

22. A computerized game and physical game piece combination according to claim 16, wherein said game piece comprises a serial number.

23. A computerized game and physical game piece combination according to claim 16, wherein said home page comprises a means for registering the game piece.

24. A computerized game and physical game piece combination according to claim 23, wherein said home page comprises a link to a web page allowing members of the online community to participate in a game piece treasure hunt.

25. A computerized game and physical game piece according to claim 24, wherein the treasure hunt comprises a means for awarding prizes linked to a game piece.

26. A computerized game and physical game piece combination according to claim 16, wherein said home page comprises a means for registering a new player account.

27. A computerized game and physical game piece combination according to claim 16, wherein said home page comprises a means for accessing an existing account.

28. A computerized game and physical game piece combination according to claim 16, wherein said computer controlling commands facilitate communication between at least two members of the group consisting of a plurality of game piece profiles and a plurality of member profiles.

29. A computerized game and physical game piece combination according to claim 16, wherein said computer controlling commands comprise a security system for allowing authorized users access to the game.

30. A computerized game and physical game piece combination according to claim 16, wherein said computer controlling commands initiate said game piece profile generator upon a player registering a game piece.

31. A computerized game and physical game piece combination according to claim 16, wherein said computer controlling commands initiate a sequence by which a player uploads an individualized design for publication on a game piece.

32. A computerized game and physical game piece combination according to claim 16, wherein said computer controlling commands initiate editing features for updating either a game piece profile or a member profile.

33. A computerized game and physical game piece combination according to claim 32, wherein said editing features related to a game piece profile are selected from the group consisting of adding a picture of a game piece, naming a game piece, listing physical locations of the game piece, illustrating the game piece's global travels on a virtual map, listing prior owners of the game piece, changing the background of the game piece profile.

34. A computerized game and physical game piece combination according to claim 32, wherein said editing features related to a player profile are selected from the group consisting of entering objective information about the player, selecting a computer graphic that represents the image of the player, changing the background of the player profile, and listing other players in electronic communication with the player.

35. A computerized game, physical game piece, and game piece holder combination comprising:
a game piece for communicating and trading among players;
a game piece holder configured for carrying said game piece;
a computer network for tracking possession of said game piece and providing information about players who have possessed the game piece, the computer network comprising:
a database for assigning a unique serial number to said game piece;
a computer readable storage medium with computer controlling commands stored thereon, the computer controlling commands providing on the computer network (i) a home page for accessing the computerized game; (ii) a game piece profile generator; and (iii) a player profile generator,
wherein the players have access to both a game piece profile and a player profile published on the computer network.

36. A combination according to claim 35, wherein said game piece holder is a bracelet.

37. A combination according to claim 35, wherein the holder is adapted to be carried by the individual.

38. A combination according to claim 35, wherein the database of game pieces is populated with pictures of the game piece.

39. A combination according to claim 35, wherein said game piece holder is a bracelet defining pockets for carrying a game piece therein.

40. A combination according to claim 35, wherein said game piece holder is attachable to an item of clothing.

41. A computer program product for identifying a common interest in a single game piece among members of a social network, the computer program product comprising:
a computer readable storage medium with a database thereon for assigning a unique serial number to a physical game piece traded among individuals;
a member profile generator that is accessible by members of the social network for generating text and graphics on a computer screen and associating the text and graphics with a respective member profile within the social network;
a game piece profile generator for creating text and graphics associated with a game piece traded to or traded by a respective member of the social network;
a linking module for informing a sub-group of the social network that the sub-group has had possession of the same game piece, said linking module providing each member of the sub-group with the option of initiating communication with other members of the sub-group.

42. A computer program product according to claim 41, wherein said linking module comprises computer controlling commands allowing members of the sub-group to accept or decline the initiated communication.

43. A computer program product according to claim 41, wherein said linking module comprises computer controlling commands providing messaging capability for discussing the game piece online.

44. A computer program product according to claim 41, wherein said computer controlling commands allow access to the computer program product by entering a serial number associated with a game piece.

45. A computer program product according to claim 41, wherein said computer controlling commands publish an online contest for members of the online community to submit proposed designs for a game piece.
